(19) United States
(12) Patent Application Publication
(10) Pub. No.: US 2005/0133571 A1
(43) Pub. Date: Jun. 23, 2005

(54) Flip-chip solder bump formation using a wirebonder apparatus

(75) Inventor: Shih-Fang Chuang, McKinney, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/739,713

(22) Filed: Dec. 18, 2003

(51) Int. Cl. B23K 31/02

(52) U.S. Cl. 228/180.5; 228/4.5

(57) ABSTRACT

A method for forming solder bumps on a flip-chip semiconductor die using a wirebonder apparatus and a flip-chip die bumped according to the method disclosed. An embodiment of the invention includes feeding a solder wire through a wirebonder capillary, where the solder wire forms a solder sphere upon exiting the wirebonder capillary. The solder sphere may then be attached to a solder pad on a flip-chip die, compressing the solder sphere into a solder stud bond. The solder stud bond may then be severed from the solder wire and reflowed into a more spherical solder bump in an oven-reflow process.

### BACKGROUND OF THE INVENTION

Integrated circuits are fabricated on the surface of a semiconductor wafer in layers and later singulated into individual dies. Referring now to FIG. 1, a cross-sectional view is shown of a flip-chip die 110 assembled into a package 100. Flip-chip interconnect technology allows a die 110 (or “chip”) to be mechanically and electrically connected to a package substrate 120 through an arrangement of solder bumps 152 on the active face 112 of the die. The die 110 is first “bumped,” or patterned with solder bumps 152, which may later attach the die to a matching pattern of bumps on the package substrate 120.

After bumping, the die 110 is typically attached to the package substrate 120 active-face down (or “flipped”) by largely melting the solder bumps 152 in an oven reflow process, affixing them to the upper surface 134 of the substrate. The solder bump area may be reinforced by introducing an epoxy underfill 130 between the die 110 and the package substrate 120 in order to improve solder joint reliability. The die 110 may be encapsulated by a “mold compound” 170, shielding the die from physical damage. Conductive vertical columns, or substrate vias 124, may allow electrical interconnection through the many layers of the package substrate 120. Solder balls 180 attached to the bottom surface 136 of the package substrate 120 may allow electrical communication between the die 110 and the printed circuit board (PCB) 190 to which the package 100 may be mounted.

Referring now to FIG. 2A, a top view of the die 110 is shown with its active face 112 exposed and having a plurality of solder pads 210, upon which solder bumps (not shown for clarity) will be attached. FIG. 2B is a cross-sectional view of a solder pad 210 taken along line 2B-2B of FIG. 2A. A sputtering process may be used to form a conductive pad 220 (e.g., aluminum) on the surface of the die substrate 230, which may be silicon. The conductive pad 220 may be covered with a dielectric layer 240, such as a passivation, in which an opening 242 is created, exposing at least a portion of the conductive pad.

One or more conductive layers may then be formed over the conductive pad 220, collectively forming under-bump metallization or metallurgy (UBM) 250, on which a solder bump (not shown in FIG. 2B) may later be attached. A conductive pad 220 having an exposed aluminum surface may oxidize on contact with oxygen, forming a substantially non-conductive oxide on its surface. This oxide may be easily dislodged, exposing the conductive aluminum below, when ultrasonic energy or vibration is transmitted from the capillary of a wirebonder apparatus (not shown) to the wire. However, a layer of oxidation may prove an impediment to electrical conduction should a solder bump be placed on top of it by a conventional stud-bump bonding process.

In an exemplary configuration, the UBM 250 may have a Ni/Cu/Ti metallurgy, this nomenclature denoting that the UBM comprises a nickel (Ni) outer layer 256, a copper (Cu) middle layer 254, and a titanium (Ti) base layer 252. The composition and quantity of the UBM layers 250 may vary according to the material selected for the conductive pad 220 and the material of the solder bump to be attached to the solder pad 210. Referring now to FIG. 2C, a solder plug 260 may be formed on the surface of the UBM 250 by vapor-phase deposition (VPD), screen-printing, electroplating, sputtering or other suitable method. An oven reflow process may be used to transform the solder plug 260 into a spherical shape, as shown in FIG. 2D, forming a solder ball 270 suitable for mating to a package substrate or other board. The solder ball 270 may have a eutectic, or fusible alloy, composition.

Referring now to FIG. 3, an alternative method of attaching a standard, non-flip-chip (or wirebond) semiconductor die 310 to a package substrate 320 is shown. It will be understood that a flip-chip die 110, as shown in FIG. 2A, may have solder pads 210 disposed anywhere on its active surface 112. Further, the flip-chip die 110 may be designed to be placed active-face-down, with its active face 112 attached to and directly facing a package substrate or PCB. Conversely, a wirebond die 310, as shown in FIG. 3, may have bond pads (not shown) for receiving a bond wire 350 disposed substantially on the periphery of its active surface 312. Further, a wirebond die 310 may be designed to be placed active-face-up, or with its active face 312 facing away from a package substrate 320.

As shown, the die 310 is connected to the package substrate 320 not by solder bumps, as shown in FIG. 1, but with bond wires 350 in a “wirebonding” process. Bond wires 350 may be gold or aluminum. A wirebonder capillary 360 may be used to stitch the relatively thin, conductive bond wires 350 from the active surface 312 of the die 310 to exposed conductive metal 322 within the package substrate 320, forming a pathway of electrical communication.

Wirebonding equipment may be less expensive to purchase and operate than conventional bumping equipment. As older technology, wirebonder apparatuses may go underused as newer die designs migrate to flip-chip technology.

### SUMMARY OF THE INVENTION

Embodiments of the invention are directed to methods of forming solder bumps on a flip-chip semiconductor die using a wirebonder apparatus. Other embodiments are directed to a flip-chip die bumped according to the methods disclosed. One embodiment of the invention includes feeding a solder wire through a wirebonder capillary, where the solder wire forms a solder sphere upon exiting the wirebonder capillary. The solder sphere may then be attached to a solder pad on a flip-chip die, compressing the solder sphere into a solder stud bond. The solder stud bond may then be severed from the solder wire and reflowed into a spherical solder bump in an oven-reflow process.

### BRIEF DESCRIPTION OF THE DRAWINGS

For a detailed description of the preferred embodiments of the invention, reference will now be made to the accompanying drawings in which:

FIG. 1 is a cross-sectional view is shown of a flip-chip die assembled into a package;

FIG. 2A is a top view of the active face of the flip-chip die of FIG. 1;

FIG. 2B is a cross-sectional view of a solder pad taken along line 2B-2B of FIG. 2A;

FIG. 2C is a cross-sectional view of the solder pad of FIG. 2B, after the formation of a solder plug;

FIG. 2D is a cross-sectional view of the solder pad of FIG. 2C, after an oven reflow process;

FIG. 3 is a cross-sectional view of a non-flip-chip die during a wirebond process;

FIG. 4A is a cross-sectional view of a solder pad and wirebonder capillary prior to deposition of a solder bump;

FIG. 4B is a cross-sectional view of the solder pad and wirebonder capillary of FIG. 4A during the formation of a solder stud bond;

FIG. 4C is a cross-sectional view of the solder pad and wirebonder capillary of FIG. 4B after severing the solder wire;

FIG. 4D is a cross-sectional view of the solder pad of FIG. 4C and the resulting solder bump formed during an oven-reflow process; and

FIG. 5 is a flow diagram of a die-bumping process in accordance with some embodiments of the invention.

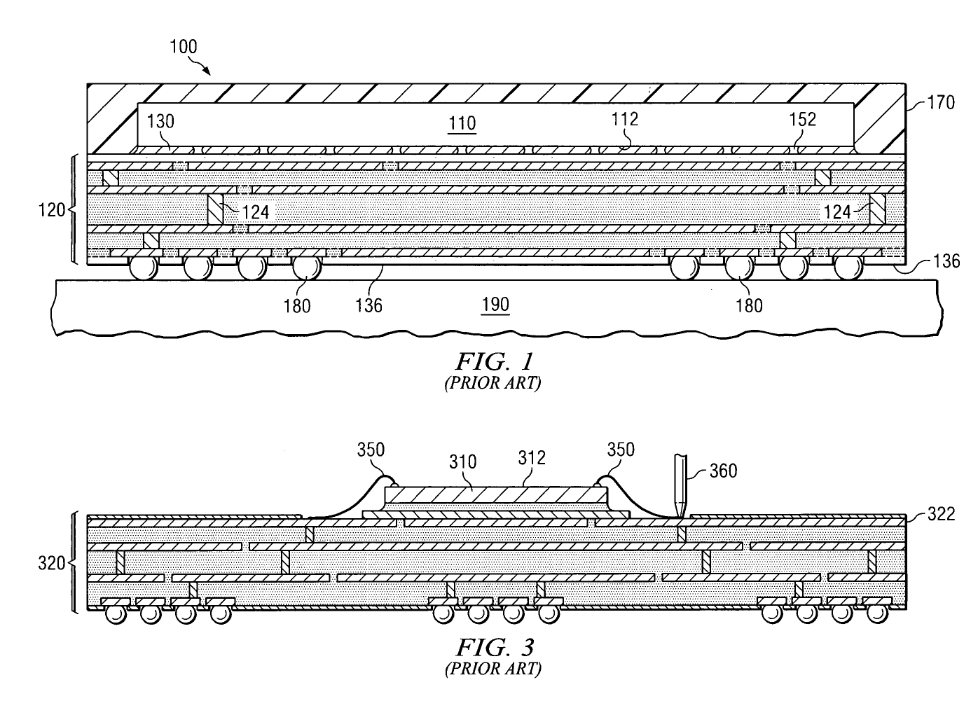

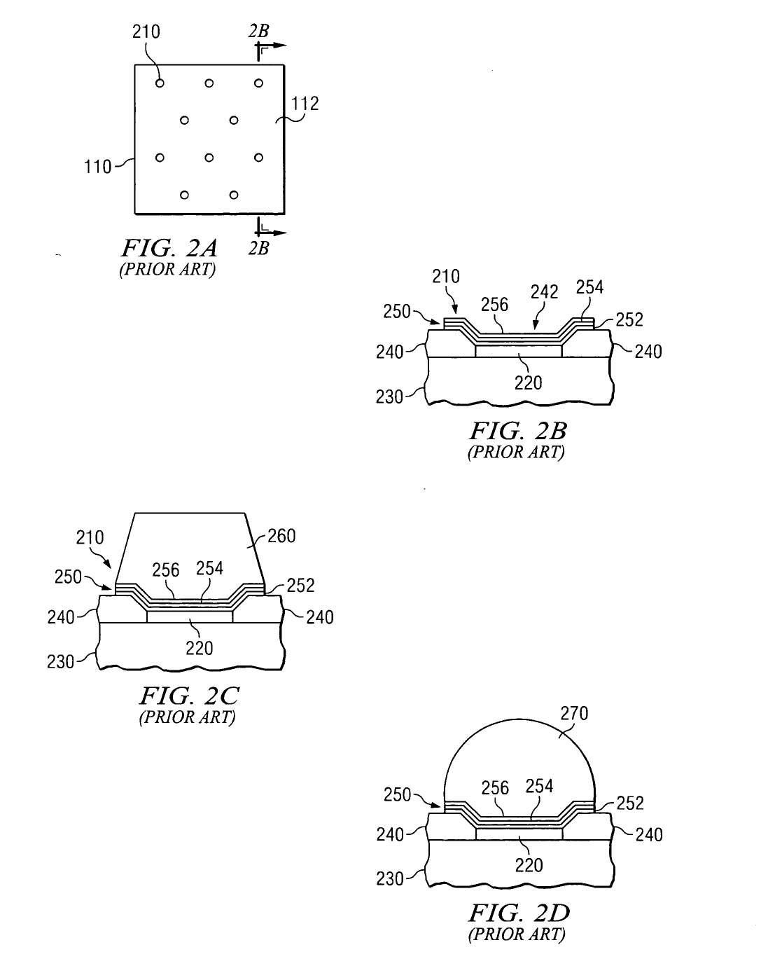

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

The term “integrated circuit” refers to a set of electronic components and their interconnections (internal electrical circuit elements, collectively) that are patterned on the surface of a microchip. The term “die” (“dies” for plural) refers generically to an integrated circuit, including the underlying semiconductor substrate and all circuitry patterned thereon. The term “wafer” refers to a generally round, single-crystal semiconductor substrate upon which integrated circuits are fabricated in the form of dies. The term “interconnect” refers to a physical connection providing possible electrical communication between the connected items. The term “packaged semiconductor device” refers to a die mounted within a package, as well as all package constituent components. To the extent that any term is not specially defined in this specification, the intent is that the term is to be given its plain and ordinary meaning.

### DETAILED DESCRIPTION OF THE PREFERRED EMBODIMENTS

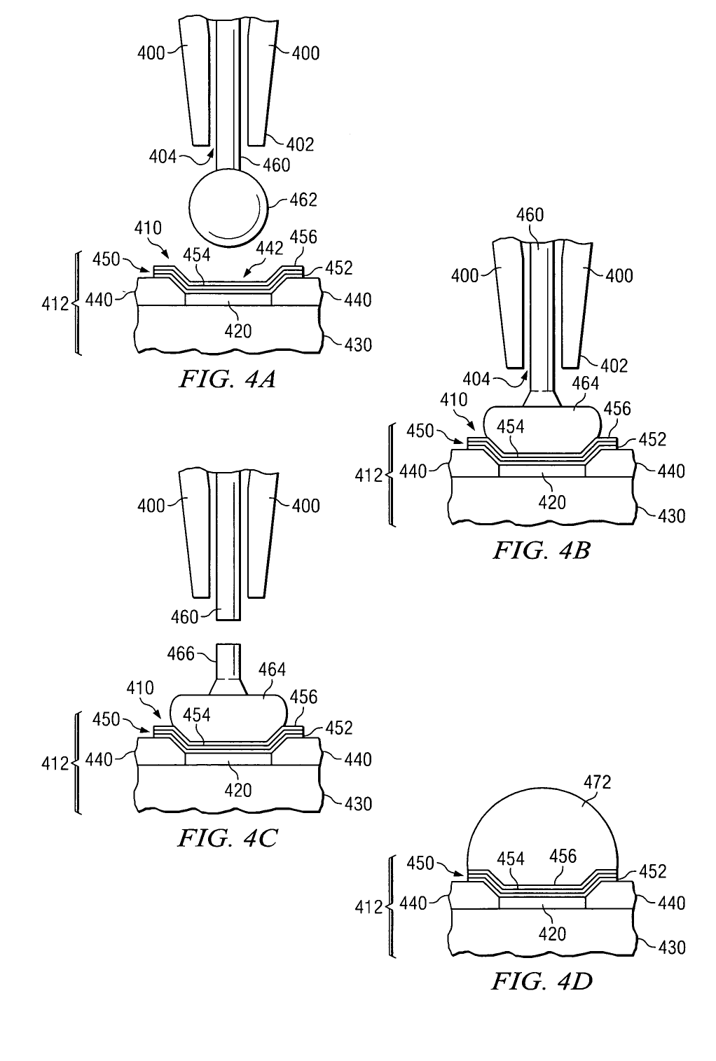

The embodiments of the invention involve using a wirebonding apparatus (or simply, “wirebonder”) with a solder material to form solder bumps on flip-chip semiconductor dies. Referring now to FIG. 4A, a capillary 400 of a wirebonder (not shown) is shown preparing to deposit a solder sphere 462 onto the solder pad 410 of a semiconductor die 412. The capillary 400 may be a thin, needle-like device comprising a small tapered tip 402 and a hollow central portion 404, through which a stream of solder, or solder wire 460, may pass. The process shown in FIGS. 4A-4D may be conducted in an elevated-temperature environment, possibly between about 125 degrees Celsius (C.) and about 225 degrees C. Upon exiting the hollow central portion 404, due to the elevated temperature and the surface-tension effect, the exposed, molten solder wire 460 may form a melted solder sphere 462 in the free air, with the solder sphere having a diameter greater than that of the wire.

The material used for the solder wire 460 may be a fusible alloy, or eutectic material. Exemplary solder materials may comprise a 63% Sn/37% Pb mixture; a high-lead, 97% Pb/3% Sn mixture, a 95% lead (Pb)/5% tin (Sn) mixture; a 90% Pb/10% Sn mixture; or various lead-free mixtures, such as tin-silver (Sn—Ag), tin-copper (Sn—Cu), and tin-silver-copper (Sn—Ag—Cu). The particular composition may be chosen depending on performance requirements or customer needs, such as an environment-friendly, lead-free device.

The semiconductor die 412 may comprise a silicon substrate 430. A conductive pad 420, such as aluminum, may be formed on the surface of the die substrate 430. The conductive pad 420 may be covered with a dielectric layer 440, such as a passivation, in which an opening 442 is created, exposing at least a portion of the conductive pad. One or more conductive layers may then be formed over the conductive pad 420, collectively forming an under-bump metallization or metallurgy (UBM) structure 450, on which the solder sphere 462 will be attached.

In some embodiments, the UBM 450 may comprise a first (or base) layer 452, a middle layer 454, and an outer layer 456. The composition of the UBM layers 450 may vary according to the material selected for the conductive pad 420 and the material of the solder ball to be attached to the solder pad 410. Copper is a preferred material for the outer layer 456 of the UBM 450, as it may have good adhesion properties with various compositions of solder. Aluminum may also be used, as the action of a wirebond capillary 400 delivering a solder sphere 462 may dislodge any aluminum oxide formed over the outer layer 456. Exemplary UBM layers 450 may comprise Cr/Cr—Cu/Cu/Au, TiW/Cu/Au, Al/NiV/Cu or electroless Ni/Au. Such nomenclature indicates that the first material mentioned in each of the previous configurations comprises the base layer 452, with each subsequent material or compound listed comprising each respective layer.

Gold (Au) and copper (Cu) may be particularly amenable to soldering, and as such, may be preferred materials for outer layers 456. The oxide that may form over an aluminum surface when exposed to oxygen may be easily dislodged when struck by a wirebonder capillary 400. As such, aluminum may also be suitably used for the outer layer 456 of the UBM 450, although many conductive materials may also prove suitable. A solder paste or flux may be applied to the outer layer 456 of the UBM 450 to aid in the adhesion of the solder sphere 462.

Referring now to FIG. 4B, the wirebonder capillary 400 may move down to contact the solder sphere 462 with the UBM 450, compressing and flattening the solder sphere to form a somewhat disc-shaped solder stud bond 464 in the process. This solder stud bond 464 is in electrical contact with the outer layer 456 of the UBM 450 as well as the underlying UBM layers and conductive pad 420, which may be in electrical communication with circuitry within the die 412. The solder stud bond 464 may be adhered to the UBM 450 by a thermosonic ball-bonding process, a process in which heat and sonic vibration is transmitted from the capillary 400 to fasten the solder stud bond to the UBM. Alternatively, a vibration bonding or thermal energy bonding process may be used to attach the solder stud bond 464 to the UBM 450. Any other method employed by wire-bonding technology of adhering the solder stud bond 464 to the UBM 450 may also be used.

Referring now to FIG. 4C, the solder stud bond 464 is severed from the solder wire 460 inside the capillary 400, which may then be withdrawn. The solder wire 460 may be severed by a flame cutoff, in which a jet of flame cuts the wire, or by other thermal or mechanical means, such as by quickly lifting the capillary 400 from the deposited solder stud bond 464, tearing the solder stud bond from the solder wire 460. After severing the wire 460, a short length of severed solder wire, or solder wire stub 466 may be attached to the non-spherical solder stud bond 464. This process may be repeated to bump every solder pad 410 on the die 412.

A wirebonder apparatus may be designed to create ball bonds similar to the solder stud bond 464, tapering into a bond wire (not shown in FIG. 4C) of a custom length. As such, the wirebonder apparatus may be configured to vary the length of the severed solder wire stub 466, according to the volume of solder desired on the solder pad. If a greater volume of solder is desired, a greater length of solder wire stub 466 may be left attached to solder stud bond 464 by severing the solder wire 460 when the capillary is farther away from the solder pad 410. Conversely, if a smaller volume of solder is desired, a smaller length of solder wire stub 466 may be left attached to solder stud bond 464 by severing the solder wire 460 while the capillary is still relatively close to the solder pad 410. Alternatively, the diameter of solder wire 460 may be chosen such to produce a smaller or larger solder stud bond 464. It may be preferably to ensure that the aspect ratio, i.e., the height-to-width ratio, of the combined solder stud bond 464 and solder wire stub 466 remains relatively low. A lower aspect ratio may help to center the spherical solder bump (not shown in FIG. 4C) created in the next process step, so that the solder bump does not flow away from the solder pad 410.

In a subsequent process, as shown in FIG. 4D, the solder stud bond 464 and adjoining solder wire stub 466 may be reflowed into a spherical solder “bump” 472. It will be understood that, depending on the wirebonder apparatus used, the solder stud bond 464 may vary from the shapes presented or the severed solder wire stub 466 may be absent entirely. One or more flip-chip dies 412 may be transferred to a reflow oven and subjected to elevated temperatures, reflowing the eutectic solder material of each solder stud bond 464 and adjoining solder wire stub 466 into a spherical solder bump 472. The processes detailed in FIGS. 4A-4D may be applied to one or more singulated dies 412, a partial wafer of dies, or as a wafer-scale process to an entire wafer of dies.

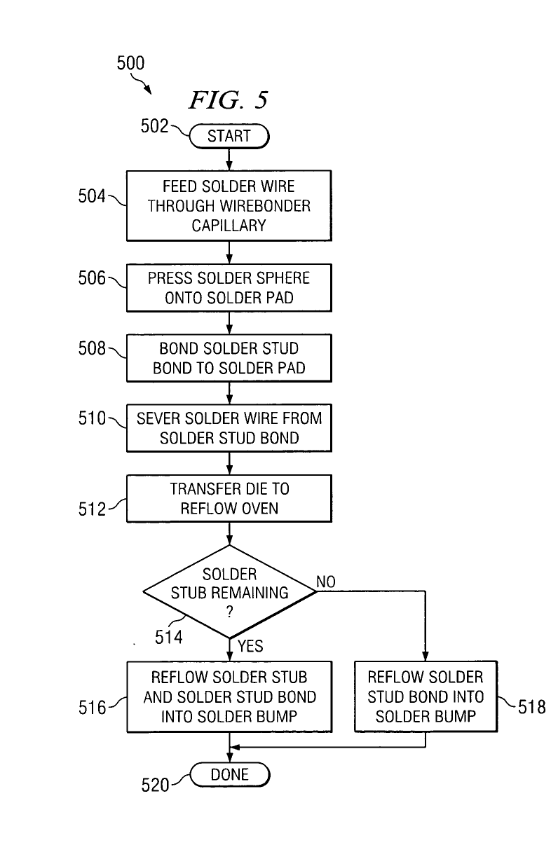

Referring now to FIG. 5, a flow diagram 500 is shown of an exemplary die-bumping process in accordance with some of the embodiments. The die-bumping process starts (block 502), and a solder wire is fed through the capillary of a wirebonder apparatus (block 504). Upon exiting the capillary, the exposed portion of the solder wire forms a free-air ball, or molten solder sphere, which is pressed into the solder pad of a flip-chip die, forming a solder stud bond (block 506). The solder stud bond is adhered to the solder pad by one of the aforementioned methods (block 508), and the solder wire is then severed from the solder stud bond (block 510). The die(s) may then be transferred from the wirebonder apparatus to a reflow oven (block 512). There may be a solder wire stub attached to the solder stud bond (block 514). If so, both the solder stud bond and attached solder wire stub may be reflowed together to form a solder bump (block 516). If not, the solder stud bond may be reflowed to form a solder bump (block 518). Some time thereafter the process ends (block 520).

An exemplary oven-reflow process may involve placing the flip-chip die(s) to be reflowed into an oven having several temperature zones. The temperature within the reflow oven chamber may be adjusted through heated air (or convection) process or alternatively, by an infrared heating process. The temperature of the reflow oven may ramp from room temperature (at which the dies(s)) may be inserted into the oven) to a peak temperature, and then may ramp back down to a cooler temperature. The ramp rate and peak temperature may depend on the solder composition. For example, for a eutectic Sn/Pb-composition solder, the peak temperature may be between about 215 degrees C. and about 220 degrees C. For lead-free solders, the peak temperature may range from about 240 degrees C. to about 260 degrees C.

Solder materials may be formed into relatively thin wires with various diameters, depending on the size of the solder pad 410 with which they may be used, as well as the desired size of the final solder bump 472. For example, to form a solder bump 472 with a diameter of 3 mils (where one mil is equivalent to 2.54×10⁻³ centimeters), the solder wire 460 to be fed through a capillary 400 (shown in FIGS. 4A-4C) may have a diameter between about 1.5 mils and about 2 mils. The parameters of a wirebonder may be adjusted to handle solder wire, instead of the usual gold or aluminum. Further, the solder material comprising the solder wire 460 may be doped by relatively minute amounts of other materials or elements to improve material properties of the solder wire, such as the mechanical or tensile strength.

The die-bumping method of the embodiments uses wirebonder equipment to deposit solder bumps 472 onto a flip-chip die 412, instead of a vapor-phase deposition (VPD), screen-printing, electroplating, sputtering or other methods used by conventional flip-chip bumping equipment. As many assembly facilities possess these lower-end wirebonding tools, little to no capital investment may be needed to bump a flip-chip die 412 in accordance with the embodiments. A wirebonder may be easily configured to reach the interior area of the active face of a semiconductor die. An exemplary wirebonder apparatus may be the model 8028 manufactured by K&S, the K&S WaferPro, or the Panasonic FCBII, although any wirebonder capable of depositing a controllable amount of solder material onto a solder pad may be used. It will be understood that the solder bump in accordance with some of the embodiments may be formed by reflowing a solder stud bond only, or a solder stud bond with an attached severed solder wire, depending on the capabilities of the wirebonder used.

The method of using a wirebonding process to bump a flip-chip die in accordance with the embodiments may be especially beneficial to low pin-count dies, or dies having a relatively low number of solder pads. Such dies could potentially be bumped in relatively rapid fashion if capacity was an issue on more costly, higher-end standard die-bumping equipment. Relieving these capacity issues may prevent the unnecessary capital expenditures in purchasing new standard die-bumping equipment. Further, the die-bumping method of the embodiments may be employed as a wafer-scale process, on partial wafers, or on singulated dies. When utilizing the process on a whole or partial wafer, the capillary may move between dies to perform the die-bumping process. For singulated dies, the capillary, as well as the vacuum plate on which the die is restrained by suction, may move concurrently.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method comprising:
feeding a solder wire through a wirebonder capillary, wherein the solder wire forms a solder sphere upon exiting the wirebonder capillary;
attaching the solder sphere to a solder pad on a flip-chip die, wherein the solder sphere is compressed into a solder stud bond; and
severing the solder wire from the solder stud bond.

2. The method of claim 1, further comprising reflowing the solder stud bond into a solder bump.

3. The method of claim 2, wherein severing the solder wire from the solder stud bond further comprises leaving a solder wire stub attached to the solder stud bond.

4. The method of claim 3, wherein reflowing the solder stud bond further comprises reflowing the solder wire stub attached to the solder stud bond into a solder bump.

5. The method claim 1, wherein feeding a solder wire through the wirebonder capillary further comprises feeding a solder wire comprising a material selected from a group consisting of a 63% tin (Sn)/37% lead (Pb) mixture, a high-lead 97% Pb/3% Sn mixture, a 95% Pb/5% Sn mixture, a 90% Pb/10% Sn mixture, tin-silver (Sn—Ag), tin-copper (Sn—Cu), and tin-silver-copper (Sn—Ag—Cu).

6. The method of claim 1, wherein attaching the solder sphere to a solder pad further comprises attaching the solder sphere to an under-bump metallization (UBM) structure.

7. The method of claim 6, wherein attaching the solder sphere to a UBM structure further comprises attaching the solder sphere to a UBM structure having a material configuration selected from a group consisting of Ni/Cu/Ti, Cr/Cr—Cu/Cu/Au, TiW/Cu/Au, Al/NiV/Cu and electroless Ni/Au.

8. The method of claim 1, wherein attaching the solder sphere to a solder pad further comprises attaching the solder sphere to the solder pad using a process selected from a group consisting of thermosonic bonding, thermal bonding and vibration bonding.

9. The method of claim 1, wherein severing the solder wire from the solder stud bond further comprises severing the solder wire by a process selected from a group consisting of a flame cut-off process and a mechanical tearing process.

10. The method of claim 1, wherein reflowing the solder stud bond into a solder bump further comprises reflowing the solder stud bond by a process selected from a group consisting of a convection-reflow process and an infrared-reflow process.

11. A wirebonder apparatus comprising:
a wirebond capillary; and
a solder wire, wherein the solder wire passes through a hollow central portion of the wirebond capillary.

12. The wirebonder apparatus of claim 11, wherein the solder wire comprises a material selected from a group consisting of a 63% tin (Sn)/37% lead (Pb) mixture, a high-lead 97% Pb/3% Sn mixture, a 95% Pb/5% Sn mixture, a 90% Pb/10% Sn mixture, tin-silver (Sn—Ag), tin-copper (Sn—Cu), and tin-silver-copper (Sn—Ag—Cu).

13. A flip-chip die bumped according to a process comprising:
feeding a solder wire through a wirebonder capillary, wherein the solder wire forms a solder sphere upon exiting the wirebonder capillary;
attaching the solder sphere to a solder pad on a flip-chip die, wherein the solder sphere is compressed into a solder stud bond; and
severing the solder wire from the solder stud bond.

14. The flip-chip die of claim 13, wherein the process further comprises reflowing the solder stud bond into a solder bump.

15. The flip-chip die of claim 14, wherein severing the solder wire from the solder stud bond further comprises leaving a solder wire stub attached to the solder stud bond.

16. The flip-chip of claim 15, wherein reflowing the solder stud bond further comprises reflowing the solder wire stub attached to the solder stud bond into a solder bump.

17. The flip-chip die of claim 13, wherein feeding a solder wire through the wirebonder capillary further comprises feeding a solder wire comprising a material selected from a group consisting of a 63% tin (Sn)/37% lead (Pb) mixture, a high-lead 97% Pb/3% Sn mixture, a 95% Pb/5% Sn mixture, a 90% Pb/10% Sn mixture, tin-silver (Sn—Ag), tin-copper (Sn—Cu), and tin-silver-copper (Sn—Ag—Cu).

18. The flip-chip die of claim 13, wherein attaching the solder sphere to a solder pad further comprises attaching the solder sphere to an under-bump metallization (UBM) structure.

19. The flip-chip die of claim 18, wherein attaching the solder sphere to a UBM structure further comprises attaching the solder sphere to a UBM structure having a material configuration selected from a group consisting of Ni/Cu/Ti, Cr/Cr—Cu/Cu/Au, TiW/Cu/Au, Al/NiV/Cu and electroless Ni/Au.

20. The flip-chip die of claim 13, wherein attaching the solder sphere to a solder pad further comprises attaching the solder sphere to the solder pad using a process selected from a group consisting of thermosonic bonding, thermal bonding and vibration bonding.

21. The flip-chip die of claim 13, wherein severing the solder wire from the solder stud bond further comprises severing the solder wire by a process selected from a group consisting of a flame cut-off process and a mechanical tearing process.

22. The flip-chip die of claim 13, wherein reflowing the solder stud bond into a solder bump further comprises reflowing the solder stud bond by a process selected from a group consisting of a convection-reflow process and an infrared-reflow process.
